(19) United States
(12) Patent Application Publication
(10) Pub. No.: US 2024/0406991 A1
(43) Pub. Date: Dec. 5, 2024

(54) BLUETOOTH RECEIVE CIRCUITRY

(71) Applicant: Oswego Properties LLC, Columbus, NJ (US)

(72) Inventor: Brian Gordaychik, Columbus, NJ (US)

(21) Appl. No.: 18/776,166

(22) Filed: Jul. 17, 2024

Related U.S. Application Data
(63) Continuation of application No. 18/663,371, filed on May 14, 2024.
Application No. 18/663,371 is a continuation of application No. 17/946,174, filed on Sep. 16, 2022, now Pat. No. 12,022,504.
Application No. 17/946,174 is a continuation of application No. 17/001,064, filed on Aug. 24, 2020, now Pat. No. 11,483,845.
(60) Provisional application No. 62/983,622, filed on Feb. 29, 2020.
(60) Provisional application No. 62/891,162, filed on Aug. 23, 2019.

(51) Int. Cl. H04W 72/542; H04W 72/0453; H04W 80/02; H04W 88/08

(52) U.S. Cl. CPC H04W 72/542; H04W 72/0453; H04W 80/02; H04W 88/08

(57) ABSTRACT

An integrated circuit may comprise memory configured to store key information associated with a symmetric key agreement and memory configured to store address information which is hidden from potential observers. The integrated circuit may further comprise circuitry configured to process a received data unit, wherein the data unit comprises a plurality of subelements, wherein a first subelement of the subelements comprises a length field and the first subelement comprises a data field having a length as specified by the length field, wherein the data field comprises another fixed length field and another data field, wherein the data unit is broadcast by an access point (AP) to a group of devices.

### CROSS REFERENCE TO RELATED APPLICATIONS

This application is a continuation of U.S. patent application Ser. No. 18/663,371, filed May 14, 2024, which is a continuation of U.S. patent application Ser. No. 17/946,174 filed on Sep. 16, 2022 which issued as U.S. Pat. No. 12,022,504, which is a continuation of U.S. patent application Ser. No. 17/001,064, filed Aug. 24, 2020 which issued as U.S. Pat. No. 11,483,845, which claims the benefit of U.S. Provisional Patent Application No. 62/983,622 filed on Feb. 29, 2020 and U.S. Provisional Patent Application No. 62/891,162 filed on Aug. 23, 2019, which are incorporated by reference as if fully set forth.

### SUMMARY

An integrated circuit may comprise memory configured to store key information associated with a symmetric key agreement and memory configured to store address information which is hidden from potential observers. The integrated circuit may further comprise circuitry configured to process a received data unit, wherein the data unit comprises a plurality of subelements, wherein a first subelement of the subelements comprises a length field and the first subelement comprises a data field having a length as specified by the length field, wherein the data field comprises another fixed length field and another data field, wherein the data unit is broadcast by an access point (AP) to a group of devices, wherein the group of devices is a subset of all devices in communication with the AP. The data unit may include a field having content selected at random and the data unit is integrity protected. The integrated circuit may further comprise circuitry configured to decrypt certain information of the received data unit, based on the symmetric key agreement, wherein some of the subelements of the data unit are encrypted and some are not and circuitry configured to instruct transmission of a message to the AP, in response to receipt of the data unit and in accordance with a transmission pattern, wherein the message is transmitted a predetermined delay from reception of the data unit and the message is transmitted between, in time, another uplink transmission and another data unit transmission of the AP.

### BRIEF DESCRIPTION OF THE DRAWING(S)

FIG. 1 is an example communication diagram of an access point (AP) and one or more stations (STAs);

FIG. 2 is a timing diagram which illustrates push based wake up messaging methods which may be sidelink based;

FIG. 3 illustrates a scenario in which a single content origin server is serving content to three different devices via three different content distribution network (CDN) providers;

FIG. 4 illustrates a coordination diagram which illustrates example coordination transmissions;

FIG. 5 illustrates a cascade transmit diagram;

FIG. 6 illustrates artificial intelligence (AI) techniques which may be employed to observe a state representation or observation representation;

FIG. 7 illustrates that request to send (RTS)/clear to send (CTS) frames may specify a duration including the CTS, trigger, uplink/directlink/downlink data unit(s), acknowledgements (ACKs) and short interframe spacings (SIFs);

FIG. 8(a) illustrates a timing diagram for receiving a random access channel (RACH) occasion bitmap;

FIG. 8(b) is a flowchart for providing information to a user equipment (UE);

FIG. 9 demonstrates that a portion of each universal signal (U-SIG) field transmitting in a plurality of frames may be buffered to form a larger data block;

FIG. 10 illustrates a flowchart for group transmission;

FIG. 11 illustrates a frame having one or more encrypted address fields in a medium access control (MAC) header;

FIG. 12 illustrates a plurality of network allocation vector (NAV) setting examples.

FIG. 13 illustrates an exemplary method for resource allocation;

FIG. 14 illustrates a two-step RACH procedure which provides information over a Data over cable service interface specification (DOCSIS) type backhaul;

FIG. 15 shows that Access Traffic Steering, Switching and Splitting (ATSSS) rules from the network may be configured to a UE and ATSSS user plane function (UPF); and

FIG. 16 shows that ATSSS rules from the network may be configured to a UE and an multipath transmission control protocol (TCP) (MPTCP) proxy.

### DETAILED DESCRIPTION OF THE PREFERRED EMBODIMENT(S)

Coordination may be among APs, among STAs or coordinated among STAs and APs. STAs may be jointly in communication with APs and/or STAs on same frequency resources and thus may need to coordinate joint transmission aspects. For example, devices may negotiate a density of phase tracking reference signals (PT-RS) from which transmitters to transmit and monitor. PT-RS density may be determined based on channel occupancy, success/failure of previous sensing results, modulation type, transmission format including subcarrier spacing bandwidth etc. PT-RS density may be determined based on QoS of data for transmission or higher layer parameters. Other parameters of the PT-RS may be negotiated, for example a transmission power, angle (beam) or the like.

Coordination may be based on capability, for example, device capability being a sensor, wearable surveillance, low/high power device, or the like or coordination may be based on release version. Coordination may involve coordination of the bands, subbands, subchannels, time/frequency resources, space resources and the like. Coordination may be achieved based on transmitting parameters for sensing by a STA or AP. In an embodiment, an AP may maintain a list of parameters for sensing and may provide them to STAs.

Coordination aspects may be shared on lower frequency bands than higher frequency bands. In an embodiment, lower frequency bands may be used for exchanging information between devices to determine a proximity of one another. Proximity information may be fed back to transmitters to determine whether a hidden node problem exists. With proximity information, two transmitters which are remote, may be able to coordinate transmissions to two receivers which are nearby. Proximity information may be shared/determined using the lower frequencies and reported to the transmitters via high frequency transmissions. This is able to occur, because the hidden node issue may not apply to the transmissions of the conflicting receivers.

Stations (STAs) may receive an allocation in time, frequency or space. In an embodiment, a STA may receive an allocation in frequency, for example, a channel, subchannel or the like and may transmit data at a given priority or higher. For example, a channel may be assigned for video, voice or high bandwidth applications and STA may transmit any priority above the given priority for the channel. Trigger frames may be used to allocate channels, bands, link identifier, AP identifier, transmitter identifier, receiver(s), group(s), for example, using a groupcast address, or the like etc. Information elements may be in the header or body portion of the message. Lower priority data may be transmitted on other channels, for example, with or without employing a listen before talk or clear channel assessment procedure, for example, based on Enhanced Distributed Channel Access (EDCA). Lower priority transmission may or may not be multiplexed instead of dropped scenarios. Trigger frames may indicate STAs by identifier, for example, mac address, AID or the like. Trigger frames may allocate a channel by a channel ID, subchannel ID or a band ID or the like. Partial allocations may also be available, for example, an entire channel allocation and a periodicity or time based allocation of another channel may be assigned. Maximum channel occupancy times (COT) may vary per receiver/transmitter and may be assigned or modified according to parameters disclosed herein.

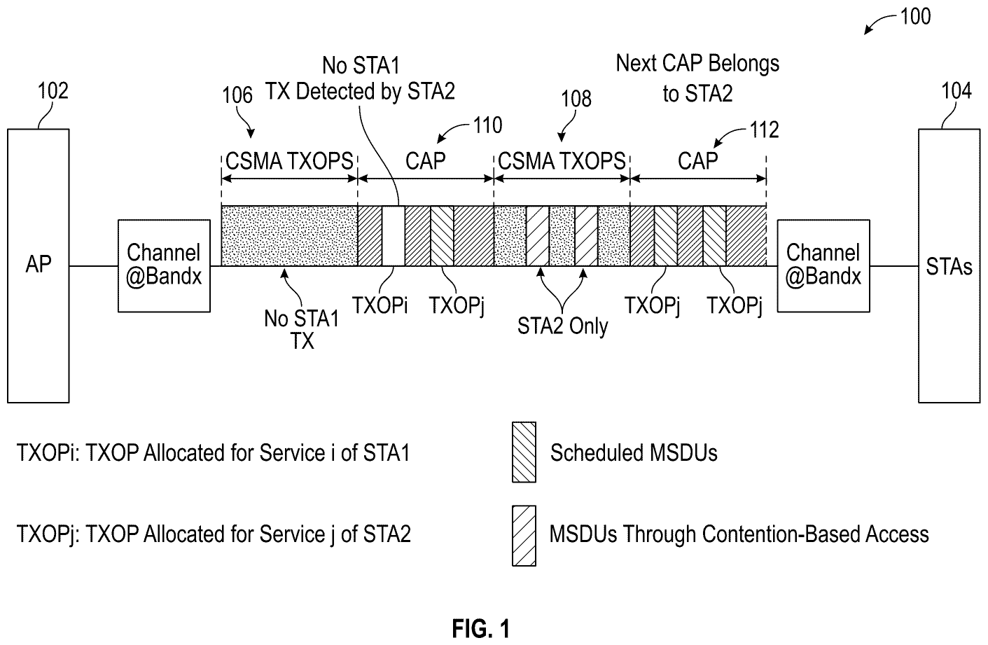

FIG. 1 is an example of an access point (AP) 102 and one or more stations (STAs) 104. As shown in FIG. 1, an AP may delineate CSMA TXOPS 106, 108 followed by CAP periods 110, 112 which are non-contention based periods. If STA2 detects that STA1 does not transmit in a first CSMA TXOP 106 and does not transmit on a following scheduled non contention based CAP transmission 110 and makes no transmission in a subsequent CSMA TXOP 108, STA2 may assume that a CAP 112 that follows belongs completely to itself, i.e. STA2. In another option, if the traffic transmitted by STA1 is periodic traffic, for example, on an x ms schedule, if STA2 detects no transmission from STA1 for this period, the STA2 may assume that a CAP which follows can be used more fully. Other network access mechanisms may be used, for example, Non-Broadcast Multiple Access (NBMA).

The use of the channel by STA2 may be more subtle than simply detecting no transmission for a period. For example, the STA2 may scan multiple channels or multiple channel bands for the transmission of STA1. If STA1 does not transmit on channel y, for example, STA2 may determine that channel x is available even though a portion of CAP has been dedicated to STA1. If STA2 detects that there are more STA2 which rely on the CAP, the STA2 may backoff the CAP or may transmit only for a reduced or random time, etc. STAs may also consider the relative power levels (for example, selected based on an instruction or previous transmission/reception) or receive an explicit indication from the STA for determining whether another STA no longer needs a scheduled resource. Transmissions to STAs or from STAs may have legacy fields used to indicate parameters to legacy type devices. Fields which follow the legacy fields, for example, HE-SIG fields (SIG-A) or (SIG-B) fields may indicate parameters for more modern type devices. A HE-SIG field may include training information and a number of training fields may be provided. The number of fields may be indicated prior to the information fields being transmitted. This way, a receiver can decode the number of fields which may be received. In addition to training information, the SIG fields may include a number of group IDs (preceded by a number of group IDs identifier. Additionally, a number of STAs may be indicated, a number of messages which follow or the like may be included in a SIG field.

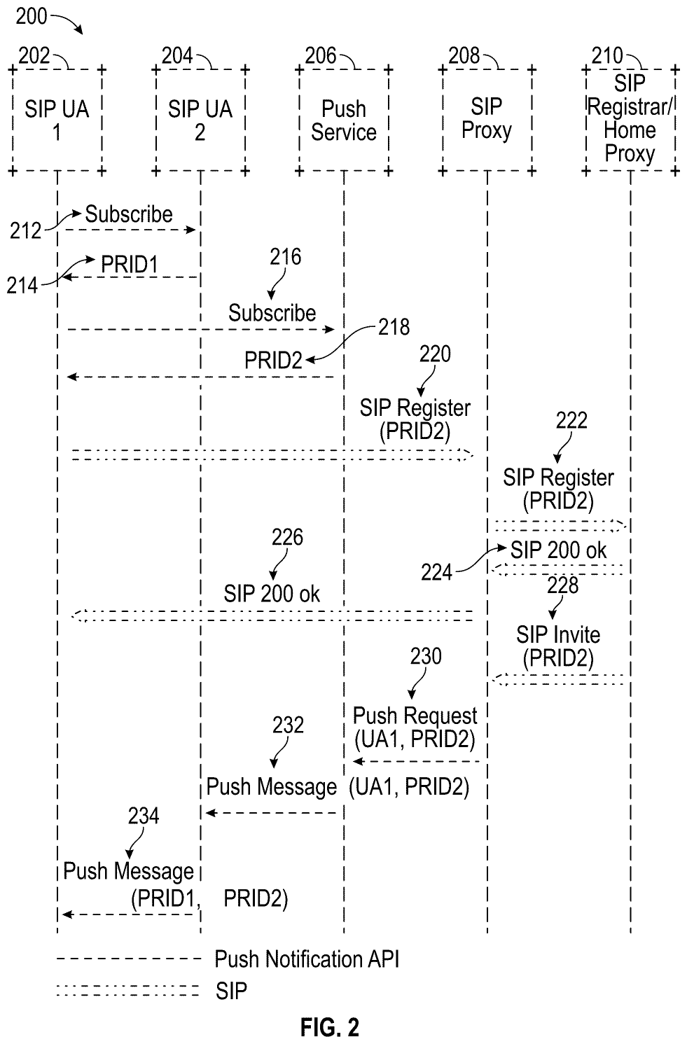

FIG. 2 is a timing diagram which illustrates push based wake up messaging methods which may be sidelink based. FIG. 2 shows a SIP UA 1 202, SIP UA 2 204, push service 206, SIP proxy 208 and SIP Registrar/home proxy 210. A SIP UA 1 202 may subscribe 212 to SIP UA 2 204 and receive a PRID1 214. The SIP UA 1 202 may subscribe 216 to a push service 206 and receive a PRID2 218. The UA may send a SIP REGISTER request 220 with the PRID2 to the SIP Proxy 208 who forwards 222 the register request to a home proxy. A SIP 200 224 may follow and be provided 226 to the SIP UA 1 202. When the SIP UA 1 202 is to be woken up, a SIP invite 228 is provided to the SIP proxy 208, who sends a push request 230 indicating UA1 and the PRID2 to a SIP UA 2 204. A push message 232 is sent from the push service 206 and the SIP UA 2 204 sends the push message 234 comprising the UA1 indicator and the PRID2 to SIP UA 1 202. In this way, a UA may be pushed a message having a PRID via a sidelink connection only. Because of this, the first UE need only monitor a sidelink channel and can subsequently turn on a long range (3GPP, WLAN, etc) transceiver.

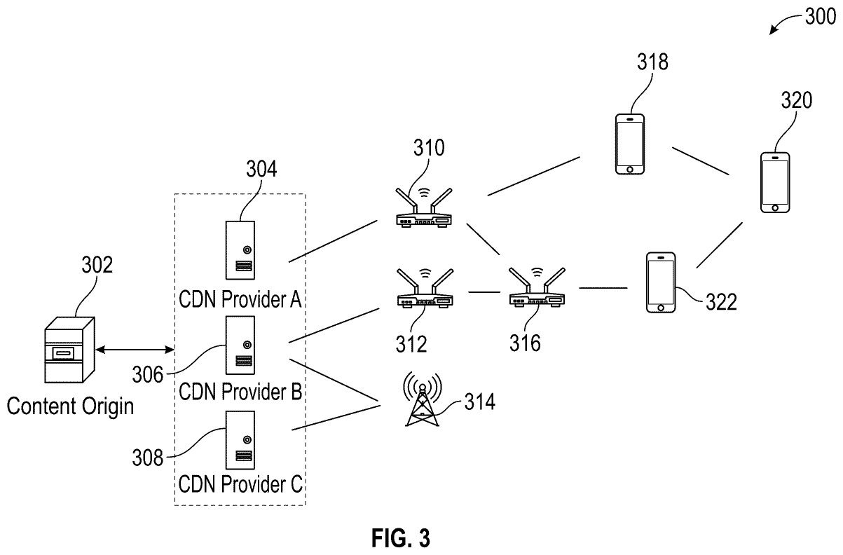

FIG. 3 illustrates a scenario in which a single content origin server 302 is serving content to three different UEs 318-322 via three different CDN providers (A, B and C) 304-308. CDN A 304 provides content to a first AP 310, CDN provider B 306 provides content to a second AP 312 and a base station 314; and CDN provider C 308 provides content to the base station 314 as well. The base station 314 may detect, via a configured bit or string in a header portion of the data content, that same data is being retrieved more than once (from CDN provider B 306 and CDN provided C 308). The base station 314 may inform CDN provider B 306 and CDN provider C 308 of the duplication via HTTP or another application layer protocol. The base station 314 may use lower level protocols, for example, if either CDN operates on a cellular core network. AP 316 may be receiving content duplicated via AP 310 and AP 312. The AP 316 may notify either AP of the duplication. The informing may be done via unicast, multicast or broadcast. In some embodiments, APs and other network elements may report support for unicast, multicast or broadcast via capability identifiers, ANQP elements or by beacon frames, probe response frames, protocol data units (PDUs) or the like. ANQP elements may be used to indicate a capability of any one of the features disclosed herein. APs and STAs may be configured to proactively cache content depending on a capability to do so. A single UE may be served by one or more relays, each relay serving multiple UEs. Each relay may serve a same or different content of the cache.

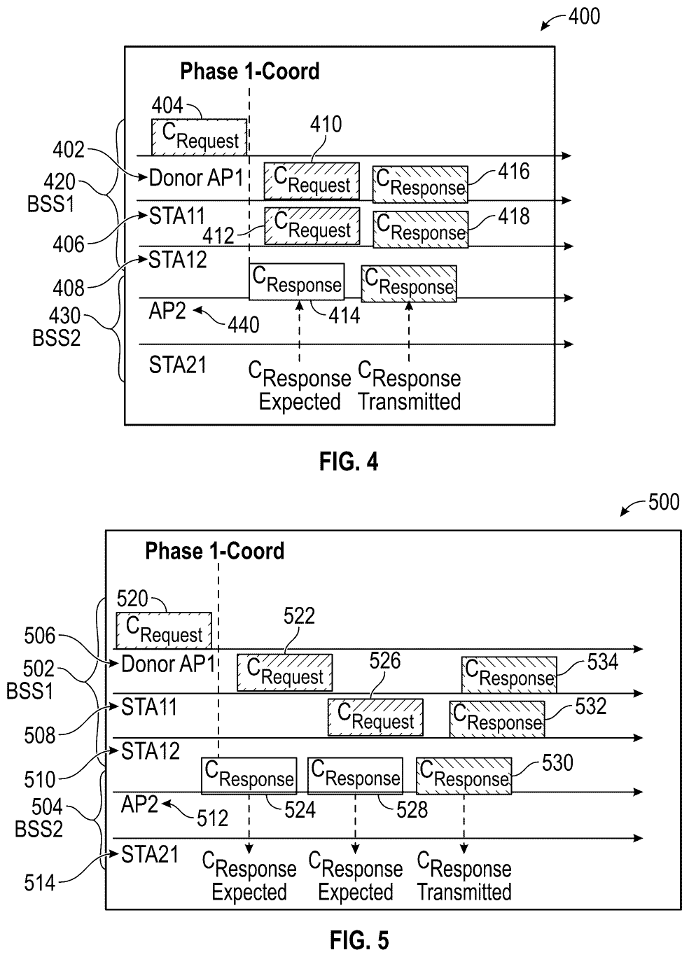

STAs or UEs may act as relays between transmitters. For example, FIG. 4 illustrates a coordination diagram which illustrates example coordination transmissions. In an embodiment, an AP may transmit a coordination request (Crequest) which is not heard by another AP. STA11 406 AND sta12 408 within the BSS1 420 may detect no coordination response (Cresponse) and may rebroadcast the Crequest 410, 412. Once the AP2 440 hears the Crequest rebroadcasted 410, 412 by STA11 406 and/or STA12 408, the AP2 440 sends a Cresponse 414 which may be appropriately forwarded 416, 418 by STA11 406 and/or STA12 408 as needed.

FIG. 5 illustrates a cascade transmit diagram. FIG. 5 shows two BSSs BSS1 502 and BSS2 504. STA11 508 and STA12 510 may be configured to cascade transmit, for example, only retransmit the coordination transmission one at a time. This may be accomplished by including a cascade indicator or sta order indicator in the Crequest frame 520. Thus, STA11 508 may first broadcast a Cresponse 522, followed by a Cresponse 526 by STA12 510 if a Cresponse 524 is not heard by the STAs. AP2 512 may continue transmitting Cresponses 528, 530. STA11 508 may transmit a Cresponse 534 and STA12 may transmit a Cresponse 532.

An order indicator may be a bitmap including STAs in a BSS or may be an indicator for STAs only in a certain direction. In any event, a group id may be included which may signal a subset of STAs who should participate in the coordination effort. Coordination may be performed for sounding purposes, thus frames may include sounding information. Alternatively, or in combination, coordination frames may be used for data transmission and scheduling, for sidelink type transmission scheduling. Coordination frames may include any parameter disclosed herein. Cascading power transmissions may be employed, similar to those disclosed in U.S. application Ser. No. 16/421,034, disclosed by reference herein.

STAs may acknowledge transmissions on one or more of potential downlink links to the STA. For example, if a STA is receiving data on two links, the links may provide the same data in duplicate, or the links may provide different data. Links may be orthogonal. Links may be transmission links and links may be reception links. Links may be fronthaul or backhaul links. Some links may have a primary channel and secondary channel. Other links may have a single primary channel. Links may be links of each one of a plurality of SIM cards. A link capability may be reported, for example, devices may announce (broadcast, unicast, or multicast) link capability information. An ACK may be provided for all data received over a time period on either link. An ACK may be provided on one link only or no ACK may be provided at all. The AP may establish a block ack agreement type and request ACKs from the STAs. The block ack agreement may apply to data transmitted on the uplink (to other STAs or to the AP) as well. Block ACK agreements may specify band, bandwidth, time etc for block ack transmissions. In some embodiments, response messages may be based on an initial transmission and thus no separate ACK need be provided. Link attributes and details may be advertised in any transmitted frame, for example, a beacon frame, an NDP frame an advertisement frame or the like.

Block Ack or other ACK frames may be segmented into different types. In an embodiment, a block ack frame may be a normal-block ACK or a link adaptation block ack frame. The link adaptation block ACK frame comprises information like suggested MCS, suggested beam information or the like. Because the link adaptation block ACK frame is larger than the normal-block ACK frame, it may not be desirable to use the link adaptation type frame at every ack transmission. For example, STAs may negotiate a pattern for providing link adaptation frames. The pattern may be specified in beacon frames or in data frames preceding the block ACK frame. The pattern may be altered by providing a link adaptation suggestion frame by the frame providing ACKS. For example, the link adaptation suggestion frame may suggest a frequency for providing MCS feedback for a duration or period. Other parameters herein may be used for link adaptation and may be negotiated accordingly. Link adaptation frames may be determined to be used based on network congestion, for example, for high data rate application in high network congestion, link adaptation frames may be used, while for low data rate applications link adaptation frames may not be used (or vice versa). Link adaptation block ACK frames may be used for shared/sharing transmissions of multi-AP transmissions.

Base stations may be able to predict load increases. For example, a base station may learn that at a given interval, a train will pass through or enter it's cell. In this way, a base station may allocate more resources for those users about to enter the cell and perform random access. The base station may limit frequency/time resources to other users within the cell for the period just before the train should enter. The base station may predict, via communication with other previous base stations, if a train is delayed and thus may delay allocating additional resources for random access or other transmissions. A satellite may perform a similar function, i.e. by understanding previous traffic conditions based on time of day, day of week, holiday, and the like, the satellite may allocate or change resources accordingly. Base stations may exchange neural network training information. For example, a base station may rely on training data sets of another base station and may discount the training set based on providing base station type, location distance or the like. Training sets may be established based on any network information disclosed herein.

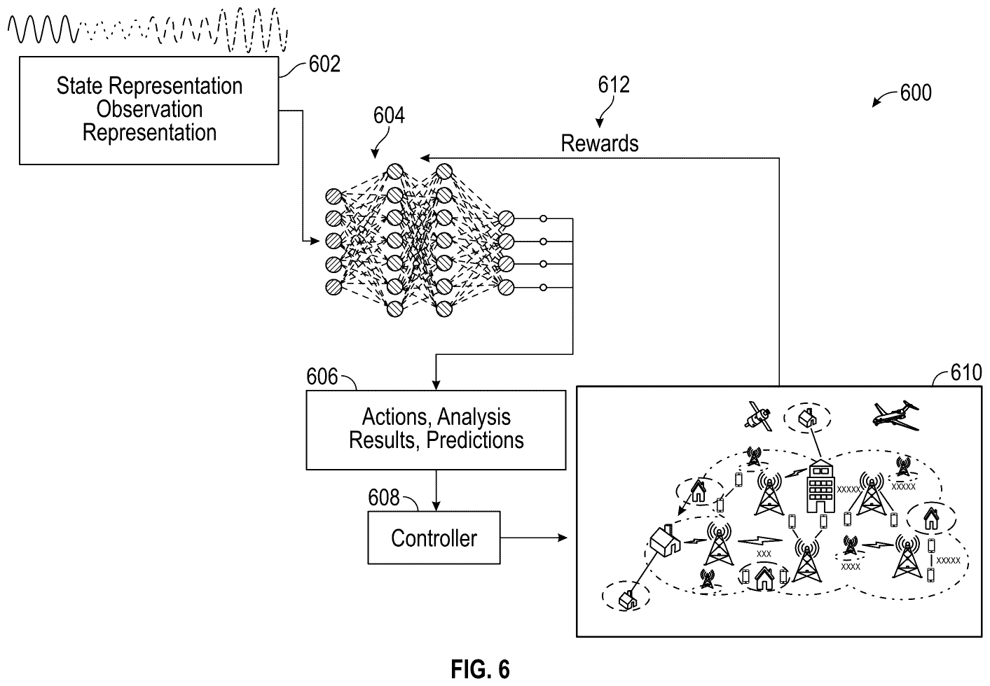

FIG. 6 illustrates artificial intelligence (AI) techniques which may be employed to observe a state representation or observation representation. A state representation or observation representation 602 may be gathered and stored in an accessible format. A neural network 604 may be used to determine actions to perform, determine results of potential actions and make predictions 606. This information may be fed to a network controller 608 which interfaces with one or more network elements of a radio access network 610 to control that element and/or the network as a whole. Reward information 612 may be fed back to the neural network. For example, AI techniques may be used to determine a number of CUs and/or DUs to deploy or instantiate or a network split type or level. Information fed into the neural network may be based on key performance indicators (KPIs), for example, KPIs based on UE type (mobile UE, handheld UE, car, train, bus, etc.).

A UE may be configured with security information (keys, certificates or the like) of another UE accessible via sidelink and may authenticate the another UE. The UE may be configured with a group ID or other ID instead of a single UE ID.

Security may be employed via physical layer, MAC layer or higher layer security procedures. Using physical layer procedures, for example, a cryptographic key or set of cryptographic keys may be derived via channel state information (CSI), beam forming information, channel statistics or other channel characteristics gleamed from measurements taken on a channel. These channel characteristics may be determined from beacon signals transmitted by an access point or via scheduled or unscheduled transmissions made by a STA. Other methods of employing physical layer security include an addition of random noise into a data transmission to degrade detection ability.

Physical layer security may be relevant with respect to V2X or D2D type device communication. A cellular network may provide parameters to aid in V2X type communication, including for example, a physical layer security algorithm to be employed, physical layer capabilities of one or more devices within a given area, modulation and coding methods for augmented security, frequency hopping and spread spectrum parameters for example, a hopping scheme or resource pool.

Physical layer security may be employed in traditional RF type transmissions and may also be employed in light based transmissions (infrared, visible light spectrum). One physical layer security technique may involve determining that a transmission by a user is at a higher receive power than expected. In this case, a malicious user may be attempting to deceive a receiving device into thinking that the malicious user is legitimate. Receiving the higher strength signal despite not signaling a TPC command instructing an increase is an indication that a malicious user has attempted an attack. Once a malicious attempt has been considered, devices may rely on other devices with known location, signal, beam, power etc. to verify whether the malicious device is who he claims to be. This may be done by group based (for example, joint transmission messages to the malicious user or single user verification messages. Response times may be calculated via response messages to the verification messages. If the response time is not appropriate, not timely or the malicious user fails to respond to a challenge correctly, one or more devices of the network may determine that the malicious user is malicious and thus disallow transmissions/receptions.

Hopping schemes may me applicable on uplink, downlink, direct link or sidelink. A UE or STA may be configured to report a capability to support various schemes, for example, time, frequency or space hopping schemes. In the downlink, an AP or BS may convey a hopping pattern for subsequent transmissions. The transmissions may follow, without the need for the pattern to be conveyed, subsequently. The transmissions may be repetitions of a same data unit or may be new data. In some examples, a portion of a transmission may be repeated thus indicating that the repeated transmission is a repeat.

In an embodiment, a UE may continuously transmit a data and/or control signal over a plurality of slots/subframes. The UE may not perform frequency hopping, for example, the UE may transmit on same frequency resources over the plurality of slots based on RRC or other layer signaling. The UE may receive, in RRC, a number of slots to monitor prior to switching to another frequency. For example, when n=1, the UE will monitor one slot prior to a switch in frequency occurring. n may be provided via RRC, MAC or DCI. The UE may request to configure n based on capabilities. N may be a number more granular than slot leve, for example, n may be symbol specific such that frequency hopping may be employed within a slot. A number of hops per symbol, subframe etc, may be associated with UE capability and/or negotiated with the network.

In embodiments, a cryptographic identifier, for example, a SHA code may precede a data portion thus indicating that a transmission is repeated. Alternatively, or in combination, when a transmission occurs within a given time/frequency or beam space, from an earlier transmission, a receiving STA may consider the reception a repetition. In some examples, only a portion of the data may be repeated, for example, by a dedicated repeater device. In the uplink, APs or BSs may use trigger frames to convey resources for uplink transmission by STAs. Patterns may be used to trigger uplink data, for example, a trigger frame may trigger frames over 1 or 2 time intervals. Alternatively, a trigger frame may be transmitted after every X uplink transmissions. Uplink or downlink data may be a mix of persistent data and periodic data. Trigger frames may be transmitted at lower data rates or coding rates than the subsequent data frames.

The trigger frame may indicate whether the frame is triggering persistent or periodic data. The trigger frame may indicate a QoS, resource allocation, (type, space or time frequency pattern type or format). If the trigger frame indicates a hopping schedule, the schedule may indicate a pattern to each STA, based on the STA order within a group or the STAs physical identifier, etc. An AP may change the pattern at each uplink transmission or the pattern may be changed every X transmission intervals. The space, time or frequency that a STA uses on uplink may be indicated in the trigger frame or the AP may preconfigure the STAs within a group with the patterns and then use the trigger frames to indicate which pattern to use. STAs may implicitly determine when to receive acknowledgements. For example, a broadcast ACK or MU-ACK. Patterns may involve scheduling resources or resource units to more than 1 STA or a single STA may be configured with multiple resource units. A STA may determine when to receive an acknowledgement based on previous ack responses. For congestion control purposes, if acks are continuously positive, the STA may receive larger size block ACKs less frequently than if frames are regularly NACKed and require retransmission by the source. This may aid in congestion control, i.e., the number of transmitted frames may be increased before an ACK is received. Block acks may increase in size, thus become delayed, as the channel conditions improve (or stay positive). Delayed ACKs may become relevant based on a QoS or latency of triggered data transmissions.

The trigger type may implicitly indicate a number of uplink transmissions to occur prior to transmission of a subsequent trigger (for more uplink transmissions). In a method, a trigger type subfield may be set to a value between 8 and 15, for example, using binary equivalents [1000], [1001], [1010], [1011], [1100], [1101], [1110], [1111]. Each value may represent a different pattern, set of patterns, pattern offset, pattern hopping, pattern sequence, acknowledgement type, HARQ/ACK type, data, control, UL beamforming (hybrid, analog, digital) training request, UL csi training request or a combination of these. Some values may specify certain power modes, for example, low medium or high power modes. Alternatively, a value greater than 15 may be used. A pattern may be indicated in part by the number of users indicated by the trigger frame. Triggers may be used to request feedback which may be time, frequency or space based. Feedback opportunities, or the desire to transmit feedback, may be based on a degree of UE autonomy, isolation and/or security. Transmission opportunities, for example, feedback opportunities may further be based on service continuity, for example, a type of service continuity.

Trigger frames may indicate resources for sidelink or direct link between STAs. A trigger frame may be provided to STAs, of which some STAs are direct link STAs, some are uplink STAs and some are downlink STAs. Using MU-MIMO and/or OFDMA, the STAs may transmit and receive simultaneously, for example, on a same link or on different links, for example, to multiple receivers or a single receiver.

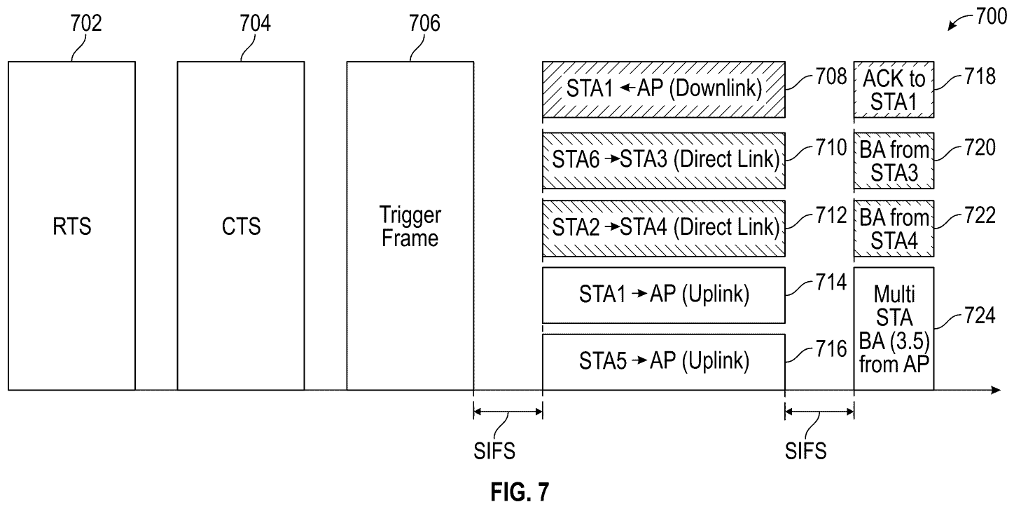

FIG. 7 illustrates that RTS/CTS frames may specify a duration including the CTS, trigger, uplink/directlink/downlink PPDU(s), ACKs and SIFs. The RTS/CTS 702, 704 may indicate that direct link transmissions are to follow. The trigger frame 706 may specify one or more: MCS indicators, STA identifiers, special assignment, frequency assignment, timing assignment, block ack types, resources for acknowledgement, resource pool information for direct link assignments or the like. In an example, the trigger frame 706 triggers a downlink transmission 708 from an AP to a STA.; a direct link transmission 710 from a STA to another STA; a direct link transmission 712 from another STA to another STA; an uplink transmission 714 from a STA to an AP; and an uplink transmission 716 from another STA to one or more APs. Acknowledgement frames 718-724 are also scheduled by the trigger frame in an embodiment.

Any frame shown in FIG. 7 may be transmitter or received simultaneously with a frame of another STA. For example, CTS frames may be provided simultaneously from STAs clearing the medium. RTS frames may be provided by the AP or STA. STA ID and link type may be indicated in the trigger frame as a bitmap. For example, a bit pattern specifying STA ID may precede bit pattern specifying link type, frequency etc.

Trigger or other resource grant messages or frames may indicate that some resources are resources of another access technology, for example, a light communication based access technology. In an example, the trigger frame may indicate whether resources are scheduled outside of a 160 mhz band, the trigger frame may indicate the access technology, for example the light type access technology. The trigger frame may indicate that a number of antennas, transmitters or light emitting diodes (LEDs) is greater than a number, for example greater than 2, 4, or 8. Trigger or other frames may specify light range in line of sight (LOS) or NLOS based topologies. Trigger frames may be transmitted from APs having broad coverage, for example, covering a plurality of LED transmitters and/or optical receivers. Trigger frames may specify duration fields so that light communication STAs may ignore transmissions for a duration, i.e. they may set a NAV for the duration.

Trigger frames may be of varying sizes. For example, a trigger frame which specifies a pattern for a plurality of users may precede a trigger frame which specifies a grant for a subset of the users or merely a change to the pattern. Trigger frames may be referred to by their bit length or occupancy time, i.e. some trigger frames may be shorter than or may convey less information than others. In an example, a transmission pattern may be provided to a plurality of STAs in a trigger frame. The trigger frame may include a random number to identify the trigger frame and subsequent UL or DL transmissions of the pattern. STAs may TX using the random identifier or a portion of the random identifier. Shortened trigger frames may be transmitted on a smaller portion of the frequency band, for example, a 20 mhz portion of a 40 mhz or larger band. The trigger may or may not be repeated in the other bands. In this way, STAs which may only operate on a band portion, may receive the trigger frame, and may act accordingly.

Trigger frames may indicate a cooperation pattern, for example, a pattern for a plurality of users to share information prior to cooperatively transmitting the combined set of information to the access point. The patterns may indicate resources for initial transmission among STAs, for retransmission among STAs and for subsequent retransmission to the AP. The patterns may change over time in the case of persistent uplink data transmission. Alternatively, the STAs need not transmit anything to the AP, rather the STAs may simply exchange information using the transmitted pattern. The AP may still indicate in a broadcast frame or other frame that the medium is busy for a duration. CSI information may follow trigger frames or may be provided by the STAs. The term STA and UE may be used interchangeably throughout this disclosure.

Patterns may be based on QoS of the uplink frames which is reported in buffer status reports or transmission requests. Patterns may be based on whether or not resources are determined available, for example, based on a LBT procedure or a plurality of LBTs performed in a band, subband or the like. Patterns may specify locations in time/frequency/space for which additional or sub-patterns may be transmitted. The sub-patterns may be or may indicate smaller or shorter patterns for UP/DL transmissions. Patterns may provide two way (or three way) resources, for example, UL, DL and SL resources, for example, in a same band or different band. Patterns may be forwarded or rebroadcasted in time/frequency/space by another AP or STA. Patterns may provide a transmission duration, for example, a duration per sector or duration per frequency or sub pattern. Patterns may indicate resources for control and data separately and may also be transmitted with pilot signals. Patterns may vary in size depending on whether or not HARQ is supported. For example, if HARQ is supported, patterns may schedule retransmission resources adaptively based on the need or based on CQ etc. DCI Control formats 3_4, 3_5 and 3_6 may include pattern information.

Patterns may be used for multi-AP transmissions, for example, transmissions from multiple APs to multiple STAs or from multiple STAs to multiple APs. Multi-AP transmissions may include a pattern frame which indicates when additional triggers, data frames, NDPs and feedback shall occur. For example, pattern transmissions may include periodic type instructions which may be for both downlink or uplink data, sounding frame transmissions to STAs followed by beamforming, CQI feedback or other feedback. Feedback may be quantized. Patterns may specify a group ID and/or order of transmissions of the STAs to one or more of the APs. Each AP may provide a group ID of which STAs may be members of. Group IDs may also be coordinated between the APs using management frames. In this way, when a group of APs signals a pattern, a single group ID may specify STAs of both APs. Pattern information may comprise reference signals, for example a sounding reference signal (SRS), phase tracking reference signals (PTRSs), pilot signals, data signals, discovery reference signals or the like. These signals may be associated with one another and/or transmitted with one another.

Group sounding procedures may reduce overhead. For example, a STA may perform sounding simultaneously with a plurality of APs and/or a plurality of other STAs. In an embodiment, a STA may receive a trigger frame indicating a STA ID, for example an association ID, transmitter ID, panel or association id/panel pair, or any combination of the same. In response, the STA may transmit on resources indicated in the trigger frame, for example, time, frequency beam resources. This transmission may be broadcast and overheard by other STAs, other APs, group transmitters, other relay STAs and other slave or master nodes (for example polling nodes) which are a given distance away. The transmissions may indicate a beam such that a receiver may derive a location of the transmitting STA. Receiving STAs may retransmit the received sounding information to other STAs based on STA movement, power, STA distance or the like. Instead of using multi-user transmission techniques, single user, for example, time delay type transmissions may occur where a STA receiving a trigger may delay based on an order or a time indicated in the trigger frame.

Transmissions, for example, UE base station(s) transmission(s) may be alined in time/frequency and not beam, for example, by using multiple spatial streams to transmit a data or control frame to the plurality of APs. This spatial stream determination may be discovered with or without receiving an indication by the APs who trigger the uplink transmission. For example, a STA may sample the trigger frame, or another frame immediately preceding or following the trigger and derive spatial stream information via beamforming or channel state detection procedures. This way, the AP(s) may also learn of a best beam(s) along with the uplink transmission by the STA(s).

APs may share a group of Traffic IDs, for example, an AP may schedule traffic to or receive traffic from a STA which shares a traffic ID with multiple APs. APs may negotiate the use of shared TID groupings which may be based on class, traffic type, STA type, capability of AP, capability of STA. The negotiation may be performed with sidelink (AP->AP) direct messages, via STA relays, via negotiation messages, via capability exchange messages, during association, during a security agreement/context or the like. Negotiation messages may also negotiate power, range, blanking intervals or no transmission opportunity times or frequencies. APs may indicate to STAs as to which AP and which link of the AP may be a best AP for the STA based on a STA request. APs may also do this via broadcast messaging which includes tables indicative of any parameter herein and a AP which may best handle that parameter, for example, a high data rate parameter, security parameter, fast link setup parameter or the like. Neighbor report messages may be used to indicate the sharing of TIDs, capabilities, etc. STAs which are non-mobile may indicate a preference to not receive neighbor reports. These STAs may determine to ignore the reports and/or not measure signals received from neighboring APs.

APs may be grouped according to capability, frequency, or other parameters that may be similar or dissimilar between the elements of the group. APs may be grouped, or identified as a group, by a STA looking to create a database of like APs. For example, a database of APs that are of a particular parameter, standard or the like.

Feedback may indicate group ID or may be directed to one or more of the APs. For example, when an AP transmits the trigger, sounding frame, NDP frame or other trigger, the STAs may implicitly transmit feedback to that transmitter or to another transmitter. NDP frames and data frames may be simultaneous or staggered, for example one follows another. If a single AP collects feedback, or acknowledgements, the AP may subsequently broadcast the information to APs within an area or multicast the feedback to APs of a group of APs. Pattern transmissions may indicate resources for the sharing of the feedback (narrowband or wideband) or acknowledgement messages. Pattern transmissions may have a dedicated 4 bit code to indicate transmission type. Furthermore, pattern transmissions of a certain type may also have dedicated 4 bit codes to indicate transmission type. Codes may be dedicated to feedback transmissions from sounding transmissions which originate from a certain AP or group of APs.

Physical layer security may or may not be applied to broadcast ACK type messages for v2x transmission. For example, there may or may not be a need to encrypt the broadcast ACK messages or portions thereof, for example, individual MAC address portions. In an embodiment, a broadcast ACK message may be transmitted to acknowledge receipt of one or more messages received from a v2x transmitter within a given period of time. The broadcast ACK may be periodic or aperiodic. The broadcast ACK may include or indicate MAC addresses (fixed or random), IP addresses, association IDs, 5G Globally Unique Temporary Identifiers (5G-GUTIs) or other address types which may be burned in addresses or assigned addresses. MAC address may return to a preset or hard coded value upon expiration of a timer or other event described herein. An IP address may be broadcast by an AP of a group of APs and the IP address may be dynamic or static as the STA is mobile. The broadcast ACK message may include an order format identifier which indicates the order of the MAC addresses. The order type may be based on channel state, RSSI, receive power level or the like. For example, the MAC addresses may be ordered from highest receive power to lowest receive power. This may provide an indication of distance and may indicate transmission power control information since a transmitter may recognize an availability to lower or increase power accordingly. In another embodiment, the broadcast ACK transmission may include a MAC or other address ordering based on location, beam or sector. This way a receiver of the broadcast ACK may order the receivers by location. Broadcast ACK messages may be transmitted in response to messages sent as disclosed herein. Based on whether or not a MAC address is found within the broadcast ACK, a transmitter may determine whether or not to retransmit an original message. In another embodiment, an ordering of MAC addresses based on time may convey a desire of the receiver to indicate a timing advance to the transmitter.

UEs may be capable of receiving 360 degree video feeds or streams that are streams of cloud based video games. The games may restrict the player to only viewing a certain portion of the feed at any given time, although it may be required to provide more than a player's instantaneous viewpoint at once. In one embodiment, in order to restrict a players viewpoint to a portion of the received video, a key may be provided which is used to decrypt only the portion for which should be visible and does not decrypt any other portion. In this way, if a player needs to change the visible portion, a new key may be requested.

In an example, a UE may use RF diffusion, penetration or reflection to estimate a user's position in space relative to the UE and/or speakers of the UE. Having located the user position, audio signals produced by the speakers may be beamformed so as to provide audio spatial effects via, for example, side firing loudspeakers. Beam feedback may be provided as signals are received based on reception interest. Audio systems may incorporate DSPs which are components of a system on a chip (SoC). SoC components may include cellular transceiver chips, radio (audio) receivers, Bluetooth, wifi chips, amplifiers, and the like. SoCs may have circuitry configured to implement Active Noise Cancellation (ANC) among the various transceiver chips. If the SoC is dedicated to a vehicle, the SoC may comprise Engine Sound Enhancement (ESE) circuitry. ANC circuitry may receive sensor data from sensors throughout the vehicle, for example, engine sensors, transmission sensors, vehicle occupant sensors, wheel sensors etc. to make a determination as to handle noise cancellation.

VLC transmitters may be used in combination with traditional radio transmitters to target augmented or virtual reality headset devices. Because these types of headsets require extreme quantities of data with minimal latency, it may be best to employ MIMO radio devices and VLC receivers (cameras) on the headsets. In this way, massive data reception may be employed for example in an office setting where each user has access to one or more lamps providing VLC, however the RF spectrum is shared among the office. The VLC transmitters may be coupled to relays/servers for providing data to the headset devices.

VLC may be used for V2X communication. For example, cameras mounted on cars may be able to ciew surroundings and also detect information modulated via other cars headlights, brake lights or other lights.

Digital signal processors may be used for controlling and driving audio systems, including amplifiers, loudspeakers, headphones and the like. DSP algorithms may correct or compensate audio signals in real time, for example, echo cancellation or echo suppression. Background sound or background noise may be suppressed. This may be achieved using beamforming and microphone arrays, located on the front, side or back of a cellular telephone or handheld device. Beamforming techniques may be used to locate objects, for example, by performing rotary type beam transmission and measuring characteristics of a receive beam. Object location may be performed sequentially, i.e. the object being located may be grossly located, for example, using RF beamforming and then finely located by adjusting a camera which may record an object, person, or the like. The camera may also be adjusted using the RF beamforming process so as to form a feedback loop.

A UE or base station may indicate a switch or change in modulation type. The switch may be an indication in any frame or frame portion herein. Modulation types which support a switch may include: Wavelength Division Multiplexing (WDM); Pulse Width Modulation (PWM); Phase Shift Keying; Under-sampled Differential Phase Shift On-Off Keying (UDPSOOK); On-Off Keying (OOK); Binary Phase Shift Keying (BPSK), Quadrature Phase Shift Keying (QPSK), Color shift keying (CSK); Under-sampled Frequency Shift On-Off Keying (UFSOOK); Under-Sampled Quadrature Amplitude Modulation with Subcarrier Modulation (UQAMSM); 16QAM; 64QAM; 128QAM; 256QAM; 512QAM/1024QAM; 2048QAM; 4096QAM; Hybrid OOK-PWM; Spatially-Modulated Space-Time (SM-ST); Layered Space-Time Code (L-STC); Spatial-Temporal Complementary Frames (S-TCF); Pixel translucency modulation; Spatial Discrete Multitone (SDMT). PDUs may indicate modulation scheme, transmit power level, BSS color, direction, ranging parameters, CRC data format, MCS or other coding, bandwidth, phase, RAT version or power threshold in a preamble. Power level or threshold may be used by a receiver to set a power level (max or min) so to be configured to transmit concurrently. A network may determine to switch to QAM modulation from another modulation and vice versa based on reporting/receiving a report of a level of phase noise.

A UE may have or may be assigned a device identifier (ID) based on the devices capabilities. The same may be true with a locator (LOC). In this way, a subset of an IPv4, IPv6, or MAC address space may be utilized for UEs of a capability or capability group. A network may employ a ID-to-LOC mapping, a LOC-to-ID(s) mapping system and a CAP-to-ID and/or CAP-to-LOC to identify a number of IDs or LOCs with which UEs exhibiting a particular capability are located. Core network nodes, base stations, UEs may all be capable of performing translation services. UEs may be located in a RAN or RANs and one or more data networks (DNs). Requests for translation may be provided by any device disclosed herein. Responses including location information may be based on a network slice location.

UEs may be capable of communicating with servers using an edge computing or multi-access edge computing (MEC) configuration. These servers may supply augmented and virtual reality images, video and other applications. Other servers may supply additional information which is provided at low latency as the servers are closer to the UE than being outside a network. A UE may report a capability to support AR, VR and HD video over an internet multimedia subsystem (IMS).

In an embodiment, a MEC configuration may encompass distributed applications running on entities which may not be trustworthy. At a minimum, at least one entity, for example, a UE may not trust a MEC Application while other UEs may have a trust policy in place. In an embodiment, a MEC application may not be collocated with data, thus forcing the MEC application to become trusted in an effort to obtain the information. A UE or MEC application may need to perform remote attestation, i.e. verify the integrity of code (or script, for example javascript or java) running remotely. Additional cryptography may be needed in the case where verified code is randomized, i.e. with a seed or other value. In an embodiment, a first UE may request that a second UE assist in verifying the integrity of an application running on a MEC application associated with or owned by the second UE. The second UE may request the MEC application perform a hash function on some code segment (either while running or prior to running), and the second UE may pass the hash to the first UE for verification. If the first UE verifies the hash, i.e. the hash matches a stored hash or a hash received from a trusted third party, for example a trust anchor, then it can be assumed that the MEC application may be trusted. In this way, by encrypting content provided between the first UE and the MEC application, the second UE may not interfere with or modify the encrypted content.

MEC application servers may be associated with satellites, blimps or other moving transmitters which may move in accordance to or with their MEC application protocols or performance. For example, various AI learning techniques may be employed here to move transmitters. As these devices move, they UEs they serve may change and those UEs may be interconnected with one or more MEC application servers. Satellites may broadcast information, via fixed or moving Earth beams, regarding their trajectory, movement, position, or the like and also they may suggest IP addresses, or other handover mechanisms for which the UE may access a new MEC application server, for example, may receive data from, such that the UE will receive data from the nearest MEC server in relation to the UE, satellite or the like. UE may request an IP address of a MEC server, from a satellite or gateway to the satellite, and may receive a response including a new IP Address or DNS information of the MEC server or group of servers, or the like. Alternatively or in combination, the UE may report satellite measurements and receive the IP address in response. Satellite measurement taking and measurement reports may be timed based on altitude of a transmitter. For example, based on an altitude, there may be less or more frequent need for measurement reporting.

Networks (including UEs, base stations and the like) may operate in various radio frequency bands. Among typical bands, including the ISM band, networks may operate in the 3.5 ghz band (between 2550 and 3700 mhz). The 3.5 ghz band may be a band with which network devices need to perform carrier sense before transmitting. Carrier sense may be performed based on radar or radar signatures in this band. Other bands include the 2.4, 5 and 6 ghz bands. STAs may exchange a capability to support simultaneous band operation and scheduling. For example, an AP may indicate via a bitmap, that data is buffered for transmission over a plurality of different bands. This determination may be based on a STAs availability to receive the data on these different bands. Some bands may be used for out-of-band type communication. Depending on band used, sub bands may be 20 mhz, 40 mhz, 80 mhz, 160 mhz, 320 mhz or 640 mhz or any combination.

In some instances, an AP or base station may configure a band or a bandwidth in accordance with one or more STAs or UEs capabilities which may be reported on a default band. In this way, the AP may save power by delaying until receipt of capabilities. An AP may operate a band in a direction only or in a plurality of directions but less than all potential directions. This may serve different capability UEs in different directions. For example, UEs of a same power capability may indicate preference to join a power capability group or may be interested in forming a group (including other interested parameters, QoS, MCS capability, etc.) based on power ability. This group preference may be broadcasted with capability information.

STAs, for example, meter type STAs may enter and resume from power save modes. Because meters communicate infrequently, it is important that only minimal bandwidth be allocated to them. Meters may be allowed to sleep until woken up. In some cases, a meter or other device may be instructed to sleep or enter a power save mode in a DCI format or other communication. The DCI may also include wake up scheduling parameters, for example, a temporal key for use upon wake up, and what to do upon wake up. A meter may or may not wake up depending on whether it has enough energy to wake up and make at least one transmission. The determination may be made based on a battery level which may be charged via light (similar to a photovoltaic solar cell solar such as one found in a calculator; a water meter may be powered by water pressure, or the like).

A UE may also include a device under test, for example, during manufacture of the device. In this way, the UE may communicate with the tools used to build the device. UEs may be powered via wireless chargers provided by the manufacturer or a different manufacturer (having a same manufacturer ID or different manufacturer ID) and may employ data communication services via the wireless doc.

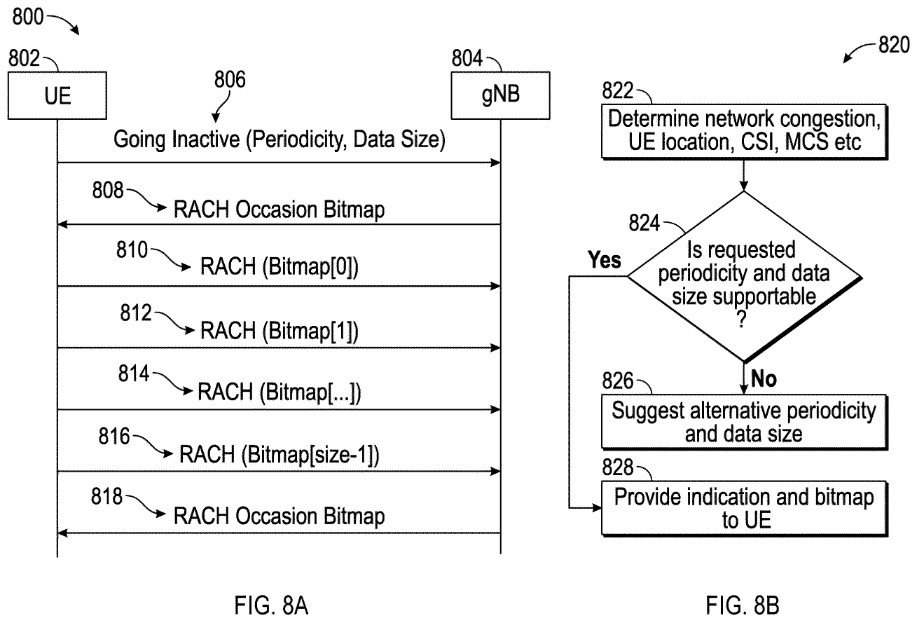

FIG. 8(a) illustrates a timing diagram for receiving a RACH occasion bitmap. A UE 802 may report 806 to a gNB 804 that it is entering inactive state. In the message, the UE may include a periodicity and data size for which the UE may report periodic small messages. In this way, the UE need not enter a connected state to transmit data. The UE may also reduce a number of transmit antennas in the INACTIVE state. In response to the suggestion to go inactive, the gNB may provide a RACH occasion bitmap 808 which indicates RACH occasions for subsequent transmission of small data. The UE may transmit at each occasion 810-816 until there are no more occasions remaining in the bitmap. At which point, the UE may renegotiate by providing a new message indicating periodicity and data size or the gNB may simply provide a new bitmap 818 given the likelihood of the UE continuing with the periodic transmissions. Periodic transmissions may be integrity protected using keys exchanged prior to the going inactive message. In another example, the RACH occasion bitmap response may comprise an encryption key or integrity protection key for the subsequent periodic message transmissions.

FIG. 8(b) is a flowchart 820 for providing information to a UE. A gNB may determine 822 whether a periodicity and data size is or can be supported 824 based on network congestion, the UE location or position, a UE mobility state (for example, PLMN mobile, handover between terrestrial and non-terrestrial), CSI, supported MCS, etc. If the request is supportable, the gNB may provide 828 an indication of such and a bitmap in a same or different message. If not, the gNB may suggest 826 a periodicity and data size which can be supported by the gNB and network.

Congestion parameters may be correlated to priority, for example, a congestion window may be used per priority and/or per one or more link(s) of a STA. A single bit or multi-bit indicator may be employed in a PDU or frame to indicate whether or not transmission/reception points, routers (including switches, other nodes, and forwarding devices), ad hoc STAs or other devices should adjust congestion windows. For example, a single bit indicator provided in a frame may indicate to a recipient whether or not the sender is increasing or decreasing the congestion window and thus the recipient should expect another packet immediately following. With a multi-bit indicator, the window may be adjusted so as to either receive a plurality of frames immediately following or to delay transmission for a given period. The period may be calculated based on the value of the multi-bit indicator. For example, based on the MCS, number of links, link quality, etc. STAs which receive the frame including the multi-bit indicator may determine a number of frames which may follow. In an embodiment, if a multi-bit indicator indicates that no frame will immediately follow the frame which includes the multi-bit indicator, 3^{rd} party receiving STAs may determine that the medium will be available shortly and for some duration. If the multi-bit indicator indicates that the congestion window shall open up, then a 3^{rd} party receiving STA may determine that a transmission opportunity on one or more link(s) will not be available for a duration. The 3^{rd} party STA may send an RTS on another link, another channel, for example, using another one or more beams or the like. A receiver of the single bit or multi bit indicator may sum the indicators to determine a window size adjustment. Packets may be marked with an indicator in a preamble, midable or data (for example payload) portion.

In Wi-Fi 7 (802.11 be), a universal signal field is proposed. The u-sig comprises a release version independent portion followed by a release version dependent portion. The independent portion conveys information which all receivers should interpret, while the dependent portion conveys information according to the release. Because this u-sig field is designed to support encoding information for future releases, there may be additional padded information at the beginning, middle or end of each field. A U-SIG field or other SIG field may comprise any field or data structure or type disclosed herein.

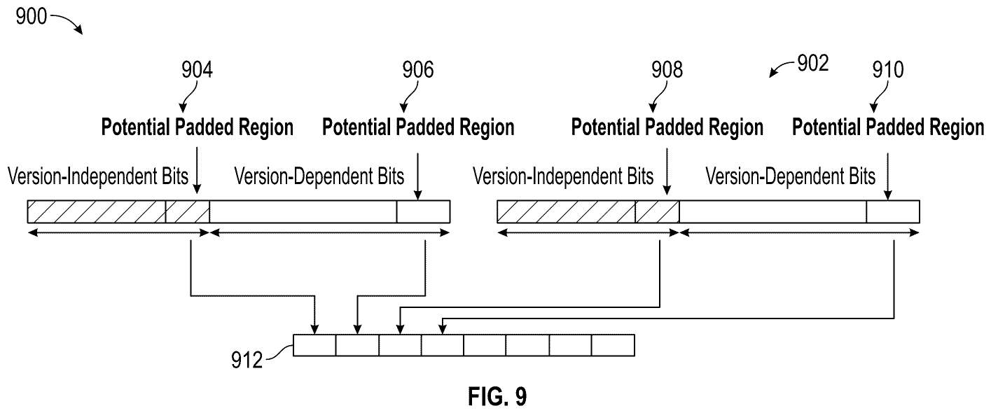

FIG. 9 demonstrates that a portion of each U-SIG field transmitting in a plurality of frames may be buffered to form a larger data block. FIG. 9 shows two U-SIG fields 900, 902 received sequentially.

A receiver may save bits of a potential padded region 904, 906 of U-SIG 900 and portions 908, 910 of U-SIG 902 to form a data block 912. Additional U-SIG portions may be appended onto data block 912 to form a larger data block.

Broadcast announcements may be used for indicating desired capabilities of coordinator (i.e. transmitter of the broadcast announcement) and desired capabilities of other APs/STAs to form a multiple access point candidate set. The multiple access point candidate set may also include APs of varying protocol/release versions. For example, the announcement may comprise a release indicator indicating a release indicator of X, below X and/or above X. In this way, release indicator may specify at least some minimum capability to join the candidate set.

Alternatively or in combination, unicast requests may be sent. The unicast requests may be sent in various directions and/or on different frequencies and time instances. The unicast requests may also comprise release indicator and desired capabilities.

Each transmission may indicate resources, for example, time/frequency resources for a response transmission. These resources may be scheduled/coordinated ahead of time via negotiation. Requests may also request specifically simultaneous transmit receive APs respond or that non-simultaneous transmit receive APs join the group.

An AP which transmits a frame to another AP, STA or group thereof may not necessarily be a coordinator AP who formed the group. Rather any AP or STA within the group may initiate a transmission among the group. When forming a group of APs for multi-AP data delivery to STAs (or other APs), a coordinating AP may define a number of potential APs with which to form the group. For example, if the coordinator requires 2 APs, and prefers capabilities above Y (among X, Y and Z capabilities), the coordinator may indicate capability and number of APs in a broadcast message. Assuming there are 2 Y capable APs in range of the broadcast message, both may respond on same resources. However if there is 1 Y capable device and 1 X capable device, the 1 Y device may respond on a first in time resource, while the 1 X device responds at a later time instant. In this way, The X device may determine that less than 2 capable devices responded and thus should also indicate availability. However, if the X capable device hears that 2 Y capable devices have responded, there is no need for the X capable device to respond. This may be enabled due to each device understanding the U-SIG field indicating release version.

A release version may indicate a maximum capability supported by an AP. In this way, for example, if a STA is associated with two APs, and receives frames from both APs, the STA may respond to both APs with a frame indicative of a minimum of the two release versions. This way both APs may successfully receive a frame transmitted to both APs.

A STA may request APs of a given capability form a group. The STA may broadcast a message indicating BSSID, link parameters of the AP, QoS requirements, STA capability, group capability etc. The request may be looking for an already formed group of APs, or to indicate to the APs that they will need to form a group.

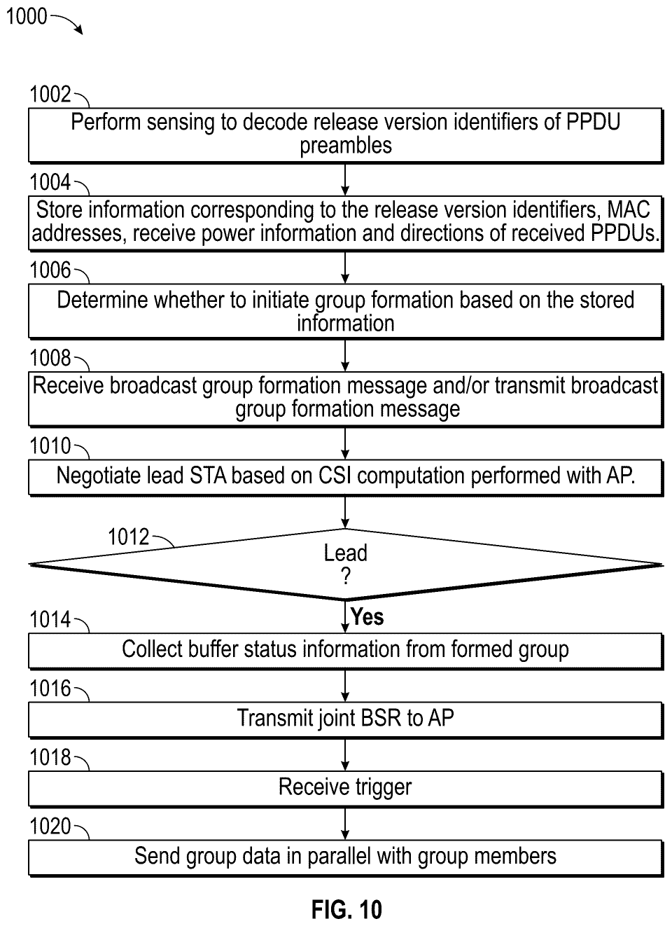

FIG. 10 illustrates a flowchart for group transmission. In an embodiment, a STA or AP may perform sensing 1002 to decode release version identifiers of PPDU preambles. Information corresponding to the release version identifiers, MAC addresses, receive power information and directions of PPDUs may be determined 1004. Whether to initiate 1006 group formation based on stored information may be determined. Broadcast group formation information may be determined 1008 based on the stored information. A lead STA may be negotiated 1010 based on CSI computation performed with an AP or other STA. If a devices is determined to be a lead 1012, buffer status information may be collected 1014 from the group. A joint BSR may be transmitted 1016 and a trigger received 1018. Group data may be sent 1020 in parallel with group members.

STAs and APs may perform sensing to discover nearby devices. In an embodiment, sensing may comprise decode release version identifiers of single user or multi user PDU preambles. Tables may be used to store information corresponding to the release version identifiers, MAC addresses, receive power information and directions of received PDUs. Also, neighbor reports may be used to correlate information and ascertain information about devices. Sensing may be performed over a time period signaled by another device, for example, an AP device. Sensing may be based on a parameter reaching a threshold, for example, any parameter disclosed herein. The threshold may be standardized or may be signaled by another device. The threshold may vary based on one or more other parameters.

Devices may determine whether to initiate group formation based on the stored information. For example, if discovering that a threshold number of devices are within range and have a minimum release version or other capability, a group may be formed. Otherwise, group formation may not be worthwhile. An AP may specify a message indicating a device capability and parameter(s) useful for determining group formation. For example, parameters may include signal strength parameters, capability, device type, device movement and/or position among others. In an embodiment, the AP may be an Unmanned Aerial Vehicle (UAV) which groups the devices into 3 dimensional clusters (or two dimensional clusters) for joint transmission to the group and joint reception from the devices of the group. UAVs may implement a wireless backhaul and may negotiate power control parameters and other transmission parameters. Groups of ground units may be formed based on interference, for example, mobile devices which experience a high degree of interferences may or may not be grouped together.

STAs which are preliminary determined to participate in a group may begin receiving broadcast or unicast group formation messages from other STAs. Based on a capability and/or desire to do so, device may transmit broadcast group formation messages. In an embodiment, group formation messages may be transmitted using incremental power so as to incrementally form a group of a given size/distance.

The group may transmit a joint BSR to AP. A trigger frame may be received in response to the BSR. Data transmissions/receptions may be performed simultaneously on same frequency/time resources by implementing group based successive interference cancellation. For STAs which have determined to not form a group of STAs, these STAs may perform SIC and may simultaneously transmit, while group members themselves are non-STR compliant when a member of the group. Simultaneous transmissions may be multi-AP transmissions, for example, multiple distinct APs, or multiple APs within a same and/or other AP.

In an embodiment, a UE may be provided with an index into a table or bitmap which indicates a resource for use in a time or frequency manner. The same table or bitmap may indicate a MCS or beam (via the index specified via DCI). The table or bitmap (indicating symbols, slots, transport blocks or the like) may be scheduled in advance via MAC, RRC etc or may be included in a DCI. In one embodiment, the table may be via a SIB. A DCI may indicate implicitly, as an offset of the DCI itself or any parameter included within, another scheduling parameter, be that time/frequency/resource/beam or the like. For example, RRC may schedule groups of resources which can or cannot be used for URLLC and a DCI may indicate one or more of the groups.

Scheduling transmissions or notification transmissions, for example, transmissions that notify spatial use or future spatial occupancy. A sync frame may be transmitted by a transmitter, for example, STA, AP, base station or the like that notifies spatial use, for example, notifies transmission direction, power, transmitter, receiver, transmission type or the like. The notification frame may be a notification indicative of a transmission of two other devices. For example, an AP may schedule one or more transmissions of two STAs which are in a same BSS or an AP may schedule transmissions for STAs which are not in a same BSS. In an example, an AP may schedule a coordinated transmission, for example, a transmission from one device to a plurality of other devices. Alternatively a transmission may be scheduled from a plurality of devices to a single AP or other device. In this way, spatial use may be optimized. The scheduling transmission may be a broadcast transmission with a broadcast identifier. The scheduling transmission may be transmitted using a beam predetermined based on a location of known or unknown STAs. There may be a duration indicated in the scheduling transmission to inform STAs of a transmission duration. A scheduling transmission may schedule a period of time for acknowledgement transmission. The scheduling ransmission may also include trigger information, for example, transmission time/frequency/space information, which indicates resources for data or ack transmission. The scheduling transmission may indicate time/space/frequency information for ACKs, or block ACKs or multi-sta block acks which are on different time/frequency/space resources. These different time/frequency/space resources for data or ACK transmissions may need to be estimated based on a STA or other device movement. Thus, an AP may transmit the scheduling frame, hear the data frame that follows and then send an updated scheduling frame or short scheduling frame so as to update other STAs of the next ACK frame that may follow. An initial scheduling frame may include counter that changes each time a scheduling frame is transmitted. This way, a receiving STA which is mobile may not receive each scheduling frame, but may maintain a table or databse over time indicative of where other STAs are located, prior MCS values, etc and may update this table accordingly. The counter may wrap around once a predetermined value is exceeded. The counter may be used to update the different channel state or channel quality values received by scheduling transmissions. Scheduling transmissions may be appended to beacon or other frames transmitted by an AP.

Network topologies may include coordinated transmission topologies or joint transmission topologies. Transmissions/receptions may be made simultaneously by a plurality of APs, a plurality of STAs, a plurality of UEs, a plurality of gNBs or base stations or the like, for example, if an RSRP of transmissions from the group of transmitters is greater than transmissions from one or the other. Availability and scheduling for simultaneous transmission, overlapping transmissions or individual transmissions may be coordinated by a controller which operates on a publish/subscribe model via pub/sub messages. Controller may relay information on any information element described herein. Parameters may be provided and requested alternatively or in combination. Each AP may subscribe and thus receive information for use. Some APs of the set may be configured to operate on a 320 mhz bandwith while other APs may be configured to operate on a 160 mhz band. Channels may be aggregated to reach these bandwidths. Transmissions may be coordinated by sending NDPs by an AP or STA to another BSS and receiving sounding responses. If a response is positive, i.e. above a threshold, the AP or STA who sent the NDP may not send transmissions in that direction (using the same beam) in future transmissions to the BSS of which the AP or STA is a member. This information, including the location, selected beam, transmission time and feedback quantity/type/results may be shared among APs and among STAs. A responder of the NDP may broadcast the feedback to multiple BSSs when the NDP indicates to do so.

When UEs on a train enter a new cell, the UEs need to perform handover at a same time on a same cell. This may limit performance. In one embodiment, a train may signal to each UE of the train, random access parameters for example, a preamble such that each UE has a unique preamble or subset of preambles to use for random access. In this way, a ground based base station is not bombarded by handover devices. The train may signal the preambles or subset thereof via a mounted transmission/reception point which has circuitry dedicated for this purpose. The signaling may be cellular signaling or wireless local area network signaling. The signaling may be on frequencies dedicated for train communication and thus may only be used by the UEs in this scenario.

Train safety measures may include red light signal RF transmission, via directional RF transmission and via broadcast for other trains; dual rf and track based transmission; conductivity checking over a track segment ahead, for example, a bridged section; ensuring that brakes are applied to a correct train; confirmation of brake application/engagement and RF reception of said confirmation of brake engagement; per wheel/per train car derailment detection and broadcast notification, for example, in a 5.9 GHz band; train segment attachment detachment determination; remote display of all trains and train cars engaged/connected to network; radio signaling of hazardous materials, for example, explosive materials; a data recorder may be configured to intercept, record, and may provide PHY, MAC or higher layer signaling to train, from train, or the like; and data transmission of door open events, door close events, train departure events, and train arrival events. The 5.9 GHz band may be applicable for any train type communication.

Train communication overload may occur when multiple trains pass through a radio cell termination, for example, at a point of handover. Each train may have it's own RF transceivers plus the train may be carrying many passengers. Thus, it may be preferable to prioritize transmissions, such as control transmissions, data transmission, RACH transmissions of the train equipment over user equipment. The opposite may also be true, for example, for high priority UE transmissions such as emergency event transmissions of UEs. A UE may be configured to not transmit data when the UE is known to be on a train which needs to perform RACH. The train may broadcast delay information to UEs for RACH. The UE may receive a RACH transmission pool or a limited RACH transmission schedule via sib or via the train. UEs/STAs may also receive pools for coordination and broadcast resource scheduling.

Trains may be configured to share RF and act as relays for UEs. This may occur via satellite or other means. Trains may be configured to slow down in hazardous areas which may be more risky than other areas. Trains may employ derailment sensors for determining whether brakes need to be applied or if the train should be slowed. Wind sensors, snow/ice sensors, and other sensors may be employed. Power loss events, for example, power loss events from a main battery system or other power sources may cause train operation to change, for example, to slow. Notifications may be transmitted to UEs and/or to ground based receivers.

Header formats may be used to distinguish different versions of 802.11 transceivers, for example, EHT, VHT, HT etc. For example, in order to differentiate a frame from an 11ax frame, the frame may have a header comprising an RL-sig field which is not a direct (i.e. verbatim) repeat of an L-sig field. For example, an RL-sig may be computed as: L-sig XOR L-sig, L-sig logical or ‘1’ sting, L-sig xor ‘0’ string, L-sig xor STA ID, L-sig XOR group ID; L-sig XOR format specific to an 802.11 release. XOR may be replaced with a sum, subtraction, multiplicator, divison of the above mentioned fields. A fixed number of bits may be simply flipped, for example, flipping of first bit in L-sig. Header format may implicitly or explicitly indicate bandwidth, number of users, number of spatial streams, harq parameters (whether or not HARQ is supported), whether or not HARQ is supported by all relays, etc. Headers may span multiple channels, for example, 10, 20, 40, 80 mhz channels etc in which one or more fields are duplicated or spread in frequency. Fields may comprise same or different information over the channel(s). Fields may be modulated according to and MCS disclosed herein. STAs or other devices may switch channels based on capability, support or channel occupancy of other STAs. Any field, message, data structure or parameter disclosed herein may be either a fixed or variable format or length. A Boolean value may specify whether fixed or variable. If variable, a number of fields or a length field may be included to signal the length or size of a message or other field in a message of one or more layers of a network stack. Elements in a message may be variable in size, for example, with an indicator used to note a length, duration or number of bits. Subelements within variable size elements may be fixed or variable.

Mesh or other frames may preferably employ encrypted header formats. In 802.11-2016, header formats are not necessarily encrypted.

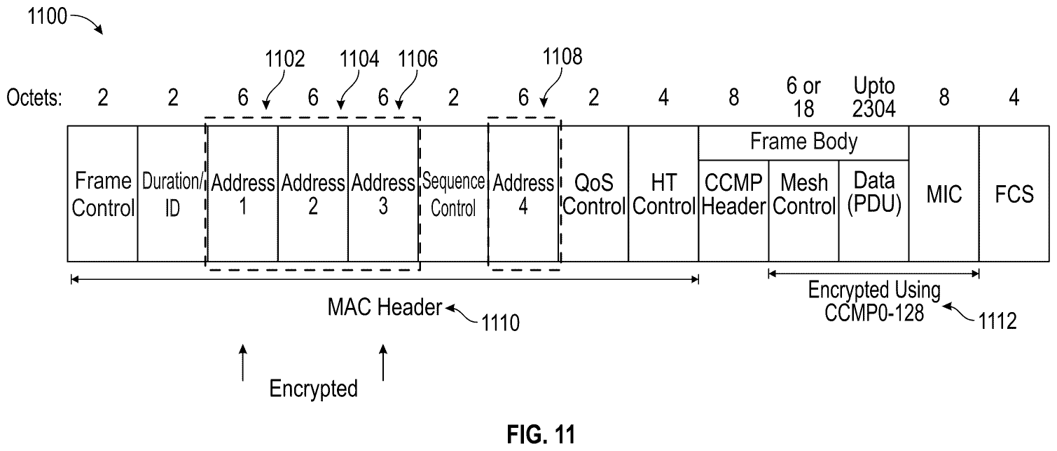

FIG. 11 illustrates a frame 1100 having a encrypted address fields address 1 to address 4 1102-1108 in a MAC header 1110. A payload portion 1112 may be encrypted.

Initially, unencrypted MAC headers may be used with frames that seek to establish a security agreement, for example, one in which a shared key agreement is employed. Frames may be duplicated, for example, in time or in frequency (different frequencies or bands). Subsequently, each address of a MAC header may be transmitted over the air such that the address is XORed with a key derived from the private key. In this way, not only is the frame body encrypted (using prior art means), but the addressed may also be hidden from potential observers. The same may be true for the FCS sequence; this may be XORed with the key derived from the secret key. In an embodiment, a duration field would not be encrypted, thus STAs which receive the frame may set their NAV accordingly.

NAV setting may occur on a channel by channel basis. For example, a wireless device may broadcast NAV setting information on multiple channels, of multiple links. For example, NAV setting information may be transmitted on a primary channel of each link. NAV setting information may be omitted, however, on another link when the NAV information becomes stale.

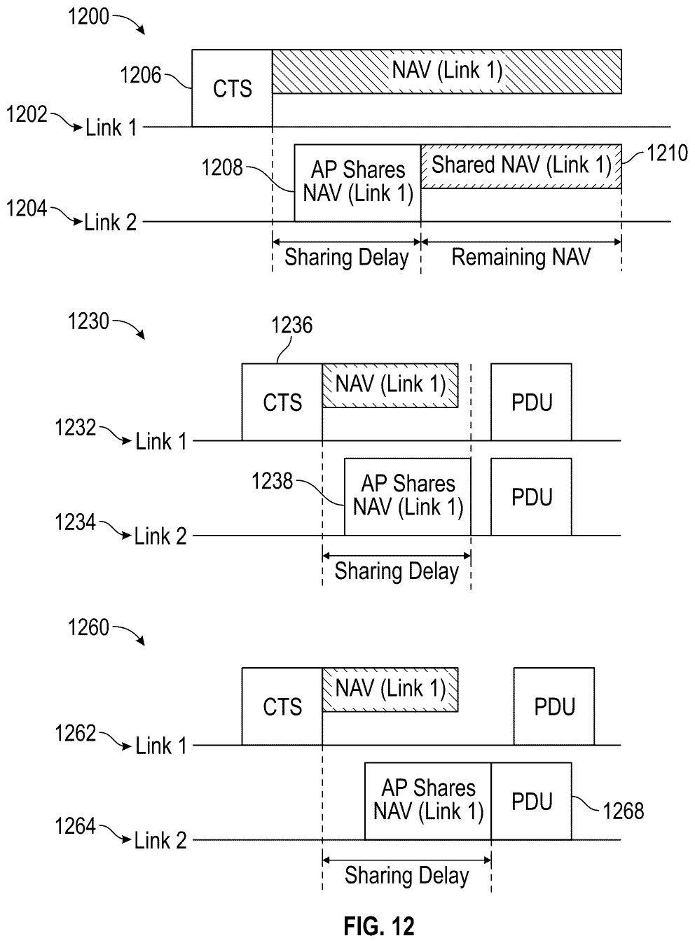

FIG. 12 illustrates a plurality of NAV setting examples. In an example 1200 a CTS 1206 is transmitted to indicate a NAV setting operation of link 1 1202, via a duration field in the CTS 1206. The AP shares 1208 the NAV setting information of link 1 1202 on link 2 1204. This may cause a sharing delay. Because the NAV setting transmission of link 1 exceeds the sharing delay, there is remaining NAV 1210.

In another example 1230, a CTS 1236 may be transmitted and if the NAV setting of link 1 1232 is made longer than the sharing delay of a message 1238 transmitted on link 2 1234, there may be no sharing delay concern, however, there may still be a need to share the NAV setting information of link 1.

At another example 1260, the sharing delay may be shortened by modifying the header of a PDU that follows 1268 on link 2 1264. In this way, the sharing delay is reduced as the PDU only becomes somewhat longer to accommodate for additional header duration information of the link 1 1262 NAV. This header information could be read, and a NAV set, all while subsequently processing the PDU 1268 being received on link 2 1264. The header of the PDU 1268 on link 2 1264 may include a variable length field or variable number of duration fields, each corresponding to a duration of a particular link. The number of duration fields may correspond to a number of links the STA is configured to monitor.

If a wireless bridge, hub or repeater is employed, the bridge, hub or repeater may or may not need to know the secret key. The frame may also be transmitted in accordance with the secret key, for example, on frequencies and/or at times which are based on the secret key or a derivation thereof.

The secret key may be provided or derived via 3gpp type access from a cellular core network. In this way, the UE may maintain multi-access PDU session(s) with the 3gpp access network and a WLAN network such that it's MAC address remains hidden and/or MAC addresses of the WLAN APs and routing elements remain hidden. Traffic steering on the WLAN may be available when the addresses are configured to be hidden.

Some APs, STAs and relay nodes may be inherently trusted or may be verified with or without the use of a 3rd party signature. Signature pairing may be based on one or more MAC address of an AP, STA or relay node. For example a signature may be based on a plurality of MAC addresses of an AP, STA or relay node. Signatures may be based on association ID. STAs, APs and relay nodes may each authenticate a content source, for example, in a multimedia broadcast or multicast system. The path to a recipient from a destination may be verified, encrypted or signed. A data unit may include fields which may be signed or encrypted by APs, STAs and/or relay nodes. AP, STA or relay node may have a public/private key pair associated with it's MAC address or AID. In an embodiment, for example, some frames may be used for source verification, while other frames are forwarded based on the source verified frames. Verified frames may be periodic or aperiodic with data frames interspersed between. Verified frames may occupy a larger or smaller frequency band than the data frames.

In some embodiments, symmetric keys may be created and exchanged between each node, for example, before a message is passed or the keys may be included with each message data, for example, a data unit. In some embodiments, a source and destination may or may not know the path to each other and thus a path may be determined by relating broadcast or other message types. In response, once the destination receives the broadcast, the destination may response using a path developed and received via the broadcast forwarded messages. The destination may respond to the source and provide a public key or other key. Each broadcast message may be a discovery type message which carries information useful for determining a shortest path routing. For example, each broadcast may include a timestamp, number of prior relaying nodes, RSSI or the like.

Each relay node may uses public and/or private keys used to generate a symmetric key. A source and destination may exchange signatures based on their association ID, MAC address(es), and the known or unknown relay nodes inbetween, for example, discovered via path selection or discovery messages.

When routing information is forwarded to a relay node, the relay node may generate a symmetric key for the source and destination based on a hash of the public keys of each and a local secret of the relay node. In this way, each node may be identified upon receiving the message. The relay node may generates an encryption key and a signature. The relay node may append the encryption key and/or signature to the data unit which may then be broadcast or forwarded to a next relay or to destination. When each relay node appends an encryption key and/or signature to a data unit, the relay node may increment (or decrement) a counter of the data unit such that a subsequent receiver may know how many keys are embedded in the data unit. Each data unit may include unencrypted public keys of the sender and recipient in each transmission from sender to recipient. Public keys of the relay nodes may also be included. Other options include sequence numbers, timestamps, IP addresses or the like.

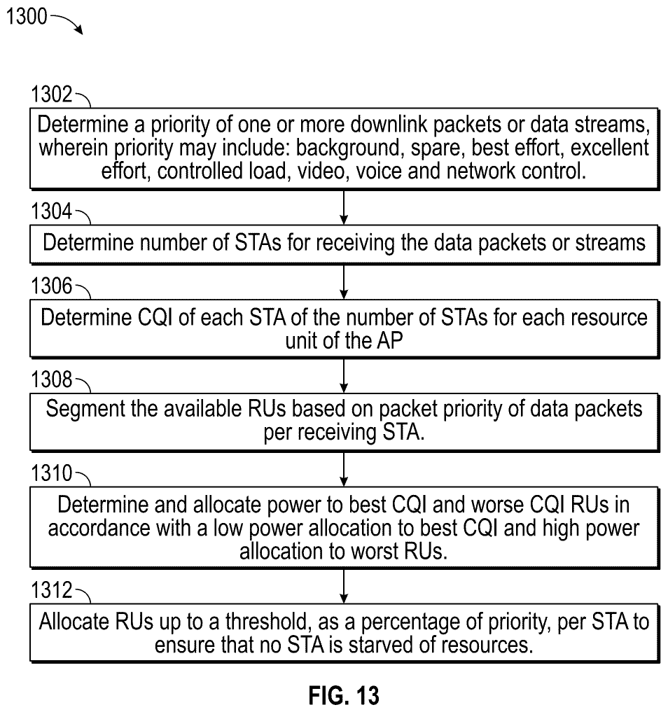

FIG. 13 illustrates an exemplary method for resource allocation 1300. In an embodiment, a priority may be determined 1302 based on one or more downlink packets or data streams. A priority may include or relate to background, spare, best effort, excellent effort, controlled load, video, voice and network control. A number of STAs for receiving the data packets or streams may be determined 1304. A CQI of each STA of the number of STAs for each resource unit of the AP may be determined 1306. Available RUs may be segmented 1308 based on packet priority of data packets per receiving STA. Power may be determined and allocated 1310 to the best CQI and worst CQI Rus in accordance with a low power allocation to best CQI and high power allocation to worst RUs. RUs may be allocated 1312 up to a threshold, as a percentage of priority, per STA to ensure that no STA is starved of resources.

SOMA or other access schemes may emply HARQ. Using HARQ, when a receiver incorrectly decoded a data unit, for example an MPDU, the receiver may transmit an ACK frame to the transmitter so as to request a retransmission of the one or more MPDUs which were received improperly. The ACK frame may not be MPDU based in some instances. For example, when FEC do not mirror or line up correctly in size with an MPDU, the receiver may indicate FEC blocks which should be retransmitted instead of MPDUs. The transmitter may then transmit only the FEC blocks (with some header overhead) which the receiver needs. Multiple FEC blocks may be transmitted in a new MPDU for the receiver to then HARQ combine with old FEC blocks of previously received MPDUs. In another embodiment, the ACK may be based on MPDU, i.e. bits may indicate failed MPDUs. However, the transmitter may, instead of retransmitting an entire MPDU, may transmit only the FEC blocks which correspond to that MPDU.

Embodiments disclosed herein may be implemented using circuitry which may include one or more of a modulator, laser diode, light emitting device (LED), circular buffer, multiplexor, first in first out buffer, last in last out buffer, last in first out buffer, strings, memory, state machines, Multiplexer/ALU, priority queue, microprocessor, registers, microcode, threaded pipeline, bus, field programmable gate array (FPGA), application specific integrated circuit (ASIC), baseband processor, video processor or other electronic circuit for that matter. ASICs and FPGAs may be programmed or provided with code wirelessly. Logical calculations may be performed on any parameter or parameters. ANDing, ORing, XORing, or the like may be performed in a logical or Boolean fashion. Circuitry may include interleavers such as LDPC block interleavers. Circuitry may be configured to generate a random number as input or compute a modulus operation. Circuitry may include equalizers for interference cancellation or other techniques. Equalizers may include spatial temporal linear equalizers including zero-forcing (ZF) and minimum mean square error (MMSE). Circuitry may also include amplifier(s) such as a power amplifier. Video circuitry may include a video processing unit (VPU) and a graphics processing unit (GPU). A display may be coupled to the GPU. Circuitry may include ciphering and deciphering circuitry. Circuitry may refer to buffer, for example, a time sensitive networking (TSN) buffer which may be supported by a UE or STA. TSN circuitry may include a time aware shaper. A UE or STA may have a transmitter, receiver or transceiver. Tracking, location or estimating circuitry may include magnetometers, accelerometers, velocity sensors and photodiodes. A UE may include circuitry including a UICC, application software (or firmware on chip), USIM, ISIM etc. A UE may be configured with Dual SIM devices.

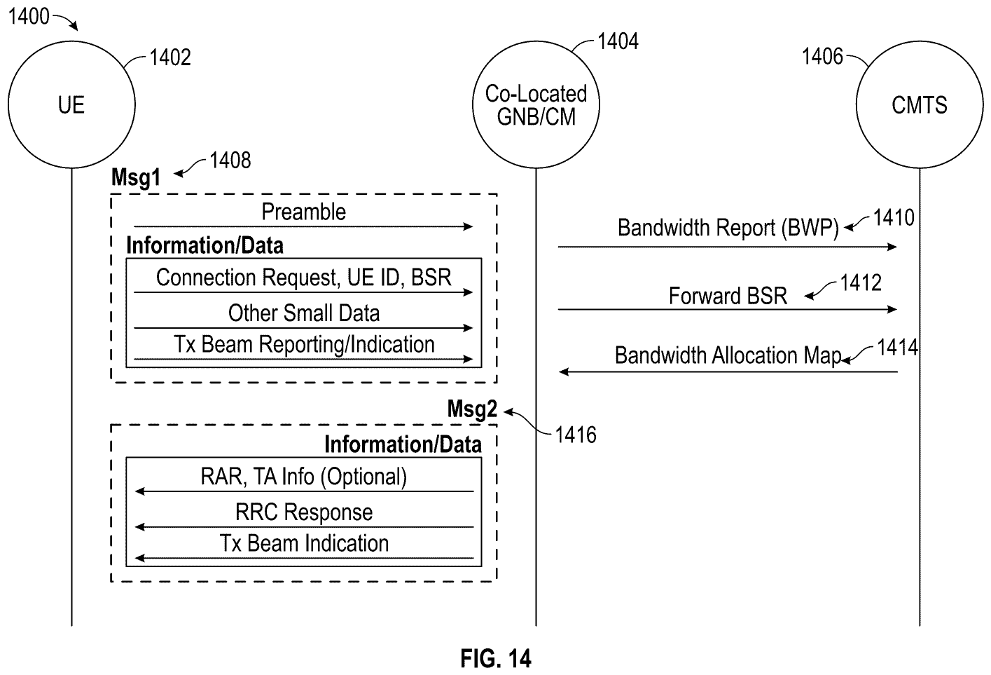

Some embodiments may rely on alternative backhaul providers which are not necessarily themselves standardized by 3GPP. For example, cable modems or fiber optic modems and network may be employed. FIG. 14 illustrates a 2-step RACH procedure 1400 which provides information over a DOCSIS type backhaul. The example shows a UE 1402, co-located gNB/cable modem (CM) 1404 and cable modem termination system (CMTS) 1406.

In the example, a UE 1402 may first transmit a preamble 1408 followed by information/data 1416. As soon as the gNB receives the preamble 1402, the gNB may signal to a collocated (or remote) CM to transmit a bandwidth report (BWP) 1410 to a CMTS. Before or upon receiving the following information/data, which may comprise other small data and a BSR, the gNB may provide the BSR information 1412 to the CMTS. In this way, the CMTS can begin to allocate bandwidth regardless of not knowing an amount of bandwidth to allocate. The CMTS may use a default value by default and then update that value upon receiving an encapsulated BSR value. Other flow control parameters may be used. The CMTS may provide a bandwidth allocation map 1414 to the gNB, via the cable modem, either before or after the gNB transmits Msg2 comprising a random access response, timing advance and the like. Alternatively, the BWP may be provided to the CMTS with an indication of BSR and thus the BWP may be delayed until the CM is in receipt of the BSR. The disclosed method may apply equally for 4-step RACH. Also, the method may apply to contention based or non-contention based RACH. In some embodiments, the gNB and CM may be collocated. In some embodiment, the gNB and CM may be separated by an access link.

Bandwidth report (BWR) messages may be transmitted by the CM at any point herein, subsequent to message(s) received by a receiver disclosed herein. For example, messages received by an 802.11 type receiver may provide BWR messages to cable networks. In an embodiment, the CM may be collocated with an 802.11 type radio transmitter or a radio of another technology. The 802.11 radio or other radio may be instantiated virtually upon receiving the preamble or other data, for example, the UE ID. In this way, CMs may perform certain additional functions for UEs, which may be for example, subscribers of the backhaul network or may be subscribers/owners of the CM. The backhaul network may supply enhanced inter-cell interference coordination (eICIC) parameters, for example bitmaps signaling transmission/no transmission, to control transmissions made by the collocated CM, the collocated gNB or the like. STAs and TRPs may coordinate null transmissions. BWR messages may be provided to the cable network via mobile edge nodes, for example, mobile edge platforms or mobile edge servers.

BWR messages may indicate a bandwidth range, for example, based on a UE capability or requested data service (surgical service, video service (glasses), etc). In an embodiment, a range may be specified for virtual reality or augmented reality applications. Bandwidth may be specified in uplink and/or downlink ranges. The BWR may specify whether rendering is performed locally, in the cloud or via a MEC application. BWR may indicate QoS or QoE. BWR messages may be provided upon a virtual machine being instantiated, for example, when a CU is instantiated.

BWR messages may be transmitted when intercell interference exceeds or goes below a threshold. BWR messages may be transmitted based on fronthaul or backhaul link condition(s), for example, link quality or throughput exceeds or goes below a threshold. Interference may be measured by determining packet or frame collisions. For example, when packets collide over the wireless network, APs and STAs may determine to create records so as to determine to transmit or defer transmission when in a location or proximity to a colliding AP or STA.

A UE may report results of the radio based measurements to a base station of a same or differing technology with which it took the measurements from. Measurements and measurement reports may be based on quality of a frequency, quality of a time or quality of a beam or beams. The UE may be configured to report periodic measurement reports based on the type of base station, type of technology used, amount of frequency used or based on a beam or beams. Reporting may be group based and in this case, a signal may be broadcasted or multicasted. The report may be sent on a set of preferred beams.

Networks herein may be software defined networks, for example, which implement application, control, and data planes. Enforcement of fine grained or gross grained policies may be performed by a device over multiple operator networks and multiple RATs using forwarding devices and control devices. Devices may determine, via control messaging, whether to endorse fine grain policies or course grain network management policies. Policies may be gross in terms of the messaging provides. For example, a subset of messaging policy messages may apply for a gross management system. A finer set of messages may be activated during fine policy control. A network may determine fine vs. gross based on number of users, signal strength, delay in the core network, delay of other networks, timeouts on packets or switches etc.

A network device, for example, a configuration server may configure forwarding or other device flow tables. Flow tables may be packet or frame based and may include routing information for control and application signaling. Flow tables may be multiple-RAT based, for example, based on the configured or capable RATs of a device. A UE which is 802.11 EHT capable may be configured with tables per link or per base station. UEs or other devices which are configured for LTE and/or NR may have cellular flow based tables, for example, based on cell, frequency beam or the like.

RATs may be domain specific, for example, relating to a service provider domain and not simply user specific. This may be true regardless of technology. Handover between the RATs may be performed on a domain basis. Sampling of processing delay and propogation delay calculation may be performed by any node herein, for example, a router, TRP (gNB, AP etc), or the like. Delay values may be reported to a central controller or other node. For example, TRP->reporting of delays may be performed. Latenc(ies) or average packet delay may be calculated at each node for reporting. Latencies may be calculated per node, per link, per cell, per group of users, per location of users, or the like.

Routing tables may be implemented at the UE per link, per cell, per RAT etc. Routing tables may be dynamically modified by the UE based on RSSI or other signal indicator and also provided by a controller. Rules may be modified based on messages received from the controller or node.

An Access Traffic Steering, Switching, and Splitting (ATSSS) user plane function (UPF) may translate access network specific addresses of each 802.11 be link into an address of a Multi-Access (MA) IP address and vice versa. Access traffic steering may include selecting a link of an AP for a new data flow and the transfer of the traffic of that data flow over the link. Access traffic switching may include migration of all packets of an ongoing data flow from one link of one AP to another link of the AP or to another access network. Access traffic splitting may include forwarding packets of a data flow across multiple access networks and/or multiple links of a single access network simultaneously.

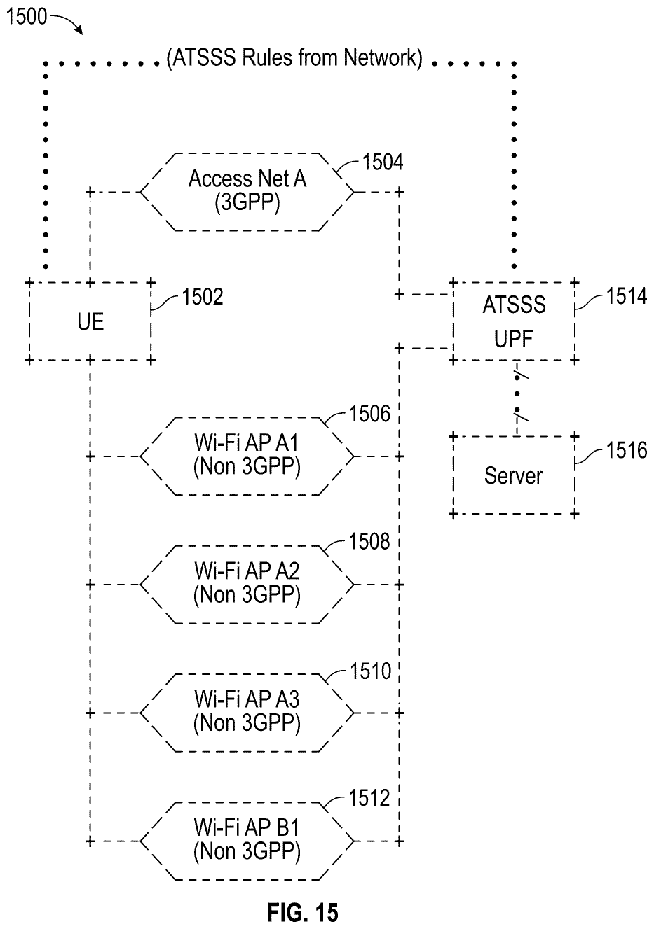

FIG. 15 shows that ATSSS rules from the network 1500 may be configured to a UE 1502 and ATSSS UPF 1514. The rules may indicate information enabling the UE to select from a 3GPP access network 1504 and a links of a first non 3GPP AP 1506-1510 or another non 3GPP AP 1512. The information may indicate that the UE should instantiate new links of an 802.11 be or greater compatible STA/AP pair or to instantiate a new non-3GPP connection.

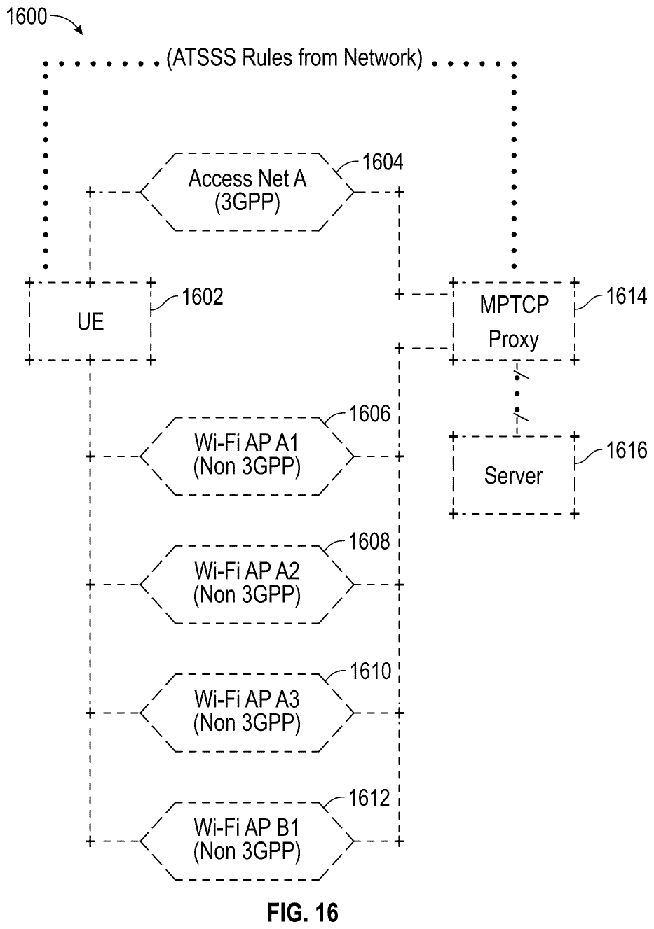

FIG. 16 shows that ATSSS rules from the network 1600 may be configured to a UE 1602 and MPTCP proxy 1614. The rules may indicate information enabling the UE to select from a 3GPP access network 1604 and a links of a first non 3GPP AP 1606-1610 or another non 3GPP AP 1612. The information may indicate that the UE should instantiate new links of an 802.11be or greater compatible STA/AP pair or to instantiate a new non-3GPP connection.

Packet order reconstruction may be based on IP address and/or IP address and MAC address pairs. For example, a MAC address may uniquely identify a link and thus may be provided up the stack correctly without first performing IP packet inspection.

What is claimed is:

1. An integrated circuit comprising:
memory configured to store key information associated with a symmetric key agreement;
memory configured to store address information which is hidden from potential observers;
circuitry configured to process a received data unit, wherein the data unit comprises a plurality of subelements, wherein a first subelement of the subelements comprises a length field and the first subelement comprises a data field having a length as specified by the length field, wherein the data field comprises another fixed length field and another data field, wherein the data unit is broadcast by an access point (AP) to a group of devices, wherein the group of devices is a subset of all devices in communication with the AP;
wherein the data unit includes a field having content selected at random and the data unit is integrity protected;
circuitry configured to decrypt certain information of the received data unit, based on the symmetric key agreement, wherein some of the subelements of the data unit are encrypted and some are not;
circuitry configured to instruct transmission of a message to the AP, in response to receipt of the data unit and in accordance with a transmission pattern, wherein the message is transmitted a predetermined delay from reception of the data unit and the message is transmitted between, in time, another uplink transmission and another data unit transmission of the AP.

2. The integrated circuit of claim 1, wherein the received data unit is modulated according to a type of Frequency Shift Keying modulation.

3. The integrated circuit of claim 1, wherein the integrated circuit operates according to frequency hopping and spread spectrum parameters.

4. The integrated circuit of claim 1, wherein a message duration of the message is shorter than another message transmitted by the wireless device to the AP.

5. The integrated circuit of claim 1, further comprising:
wake up circuitry configured to wake up receiving circuitry of the wireless device at a predetermined time instant, wherein the wake up circuitry operates in a periodic manner.

6. An integrated circuit comprising:
memory configured to store key information associated with a symmetric key agreement;
memory configured to store address information which is hidden from potential observers;
circuitry configured to process a received data unit, wherein the data unit comprises a plurality of subelements, wherein a first subelement of the subelements comprises a length field and the first subelement comprises a data field having a length as specified by the length field, wherein the data field comprises another fixed length field and another data field, wherein the data unit is broadcast by an access point (AP) to a group of devices, wherein the group of devices is a subset of all devices in communication with the AP;
wherein the data unit includes a field having content selected at random and the data unit is integrity protected;
circuitry configured to decrypt certain information of the received data unit, based on the symmetric key agreement, wherein all of the subelements of the data unit are encrypted;
circuitry configured to instruct transmission of a message to the AP, in response to receipt of the data unit and in accordance with a transmission pattern, wherein the message is transmitted a predetermined delay from reception of the data unit and the message is transmitted between, in time, another uplink transmission and another data unit transmission of the AP.

7. The integrated circuit of claim 6, wherein no acknowledgement (ACK) message is received in response to the data unit.
